(19) United States
(12) Patent Application Publication
(10) Pub. No.: US 2021/0325900 A1
(43) Pub. Date: Oct. 21, 2021

(54) SWARMING FOR SAFETY

(71) Applicants: Sunil Paul, San Francisco, CA (US); Mohamed Ahmed, el Materieya (EG)

(72) Inventors: Sunil Paul, San Francisco, CA (US); Mohamed Ahmed, el Materieya (EG)

(21) Appl. No.: 17/301,881

(22) Filed: Apr. 16, 2021

Related U.S. Application Data
(60) Provisional application No. 63/011,127, filed on Apr. 16, 2020.

(51) Int. Cl. G05D 1/02; G05D 1/00

(52) U.S. Cl. CPC G05D 1/0289; G05D 1/0295; G05D 2201/0213; G05D 1/0055; G05D 1/0293

(57) ABSTRACT

A first vehicular system may include a lead vehicle and a pod vehicle disposed behind the lead vehicle. The lead vehicle may be configured to protect the pod vehicle from a potential impact to a front portion of the pod vehicle. A second vehicular system may include a lead vehicle, a following vehicle and one or more pod vehicles disposed between the lead and the following vehicle. The lead vehicle may be configured to protect the one or more pod vehicles from a potential impact to a front portion of each of the one or more pod vehicles, and the following vehicle may be configured to protect the one or more pod vehicles from a potential impact to a rear portion of each of the one or more pod vehicles.

### RELATED APPLICATIONS

This application is a non-provisional patent application of and claims priority to U.S. Provisional Application No. 63/011,127, filed 16 Apr. 2020, which is hereby incorporated by reference.

### FIELD OF THE INVENTION

The present invention relates to swarming and platooning technology, and in particular relates to swarming and platooning technology that enhances the safety and reduces the cost of vehicles.

### BACKGROUND

Today, there are technologies capable of “swarming” or “platooning” vehicles. Currently, these technologies are used to reduce fuel consumption.

### SUMMARY OF THE INVENTION

In accordance with one embodiment of the invention, a vehicular system may include a lead vehicle and a pod vehicle disposed behind the lead vehicle. The lead vehicle may be configured to protect the pod vehicle from a potential impact to a front portion of the pod vehicle. The lead vehicle may be autonomously driven; and the lead and pod vehicles may form a heterogeneous group of vehicles.

In accordance with one embodiment of the invention, a vehicular system may include a lead vehicle, a following vehicle and a pod vehicle disposed between the lead and the following vehicle. The lead vehicle may be configured to protect the pod vehicle from a potential impact to a front portion of the pod vehicle, and the following vehicle may be configured to protect the pod vehicle from a potential impact to a rear portion of the pod vehicle. The lead and following vehicles may be autonomously driven; and the lead, pod and following vehicles may form a heterogeneous group of vehicles.

In accordance with one embodiment of the invention, a vehicular system may include a lead vehicle, a following vehicle and one or more pod vehicles disposed between the lead and the following vehicle. The lead vehicle may be configured to protect the one or more pod vehicles from a potential impact to a front portion of each of the one or more pod vehicles, and the following vehicle may be configured to protect the one or more pod vehicles from a potential impact to a rear portion of each of the one or more pod vehicles. The lead and following vehicles may be autonomously driven; and the lead vehicle, the plurality of pod vehicles and the following vehicle may form a heterogeneous group of vehicles.

These and other embodiments of the invention are more fully described in association with the drawings below.

### BRIEF DESCRIPTION OF THE DRAWINGS

The invention is now described, by way of example and without limiting the scope of the invention, with reference to the accompanying drawings which illustrate embodiments of it, in which:

FIG. 1A depicts a block diagram of a system with a pod vehicle and at least one of a lead vehicle or a following vehicle, in accordance with one embodiment of the invention.

FIG. 1B depicts a block diagram of a system with a pod vehicle without any computer or sensors, in accordance with one embodiment of the invention.

FIG. 2 depicts a block diagram of a system in a standard configuration with one or more pod vehicles and at least one of a lead vehicle or a following vehicle, in accordance with one embodiment of the invention.

FIG. 3 depicts a block diagram of a platoon of pod vehicles that breaks apart and takes evasive action when encountering a potential side impact, in accordance with one embodiment of the invention.

FIG. 4 depicts a block diagram of a configuration of vehicles, in which defensive vehicles are located on the perimeter of the platoon, in accordance with one embodiment of the invention.

FIG. 5 depicts a block diagram of another configuration of vehicles, in which a plurality of vehicles are surrounded by the lead and follow vehicles, in accordance with one embodiment of the invention.

FIG. 6 depicts a block diagram of a combination of the configurations depicted in FIGS. 4 and 5, in accordance with one embodiment of the invention.

FIG. 7 depicts electronic displays (e.g., video screens) that can be mounted on vehicles of a platoon, in accordance with one embodiment of the invention.

FIG. 8 depicts a block diagram of a configuration in which a lead and a following vehicle may offer a pod vehicle (e.g., a bicycle) protection from the elements, in accordance with one embodiment of the invention.

FIG. 9 depicts a block diagram of platoon functional zones and types of vehicles present in the platoon functional zones, in accordance with one embodiment of the invention.

FIG. 10 depicts a block diagram of vehicles arranged in within a platoon coordinate frame, in accordance with one embodiment of the invention.

FIG. 11 depicts a block diagram of an architecture of anyone of the vehicles within the platoon, in accordance with one embodiment of the invention.

FIG. 12 depicts a block diagram of the software architecture of a platoon, in accordance with one embodiment of the invention.

FIG. 13 depicts components of a computer system in which computer readable instructions instantiating the methods of the present invention may be stored and executed.

### DETAILED DESCRIPTION OF THE INVENTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. Descriptions associated with any one of the figures may be applied to different figures containing like or similar components/steps. While the sequence diagrams each present a series of steps in a certain order, the order of some of the steps may be changed.

This invention uses swarming and platooning technology in a new and useful way to enhance the safety and reduce the cost of vehicles. As is known in the art, a swarm is a collection of objects that exhibit collective behavior. A platoon is a type of swarm, particularly a swarm that is highly structured. The safety of today's automobiles and trucks are built around the idea of absorbing energy from a collision in various ways. Crumple zones and airbags, for example, are designed to absorb the energy of a collision from another vehicle. Platooning and swarming technology enable innovation in safety. These new techniques will also allow vehicles to become cheaper and enable the more rapid deployment of autonomous vehicles.

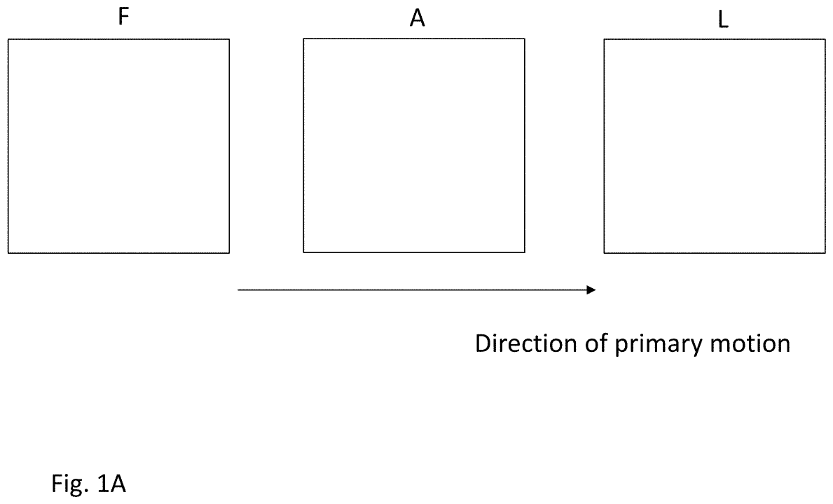

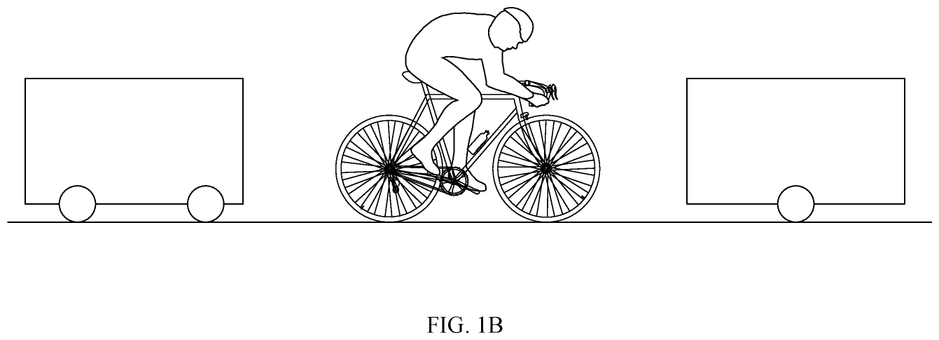

The system consists of at least two components. A “pod,” labeled as “A” in FIG. 1A, that can carry the payload of a person or cargo or both. The system also includes at least a lead vehicle or a following vehicle (also called a “follow vehicle”). These lead and follow vehicles, labeled “L” and “F” respectively in FIG. 1A, provide collision safety for the pod (A) vehicle and payload. Lead and follow vehicles may contain the crumple zones and friction with the road to limit the damage to the pod from a front or rear collision. In one embodiment of the invention, one or more of the lead, pod and follow vehicles are non-identical from one another, such that the platoon comprises a heterogeneous group of vehicles.

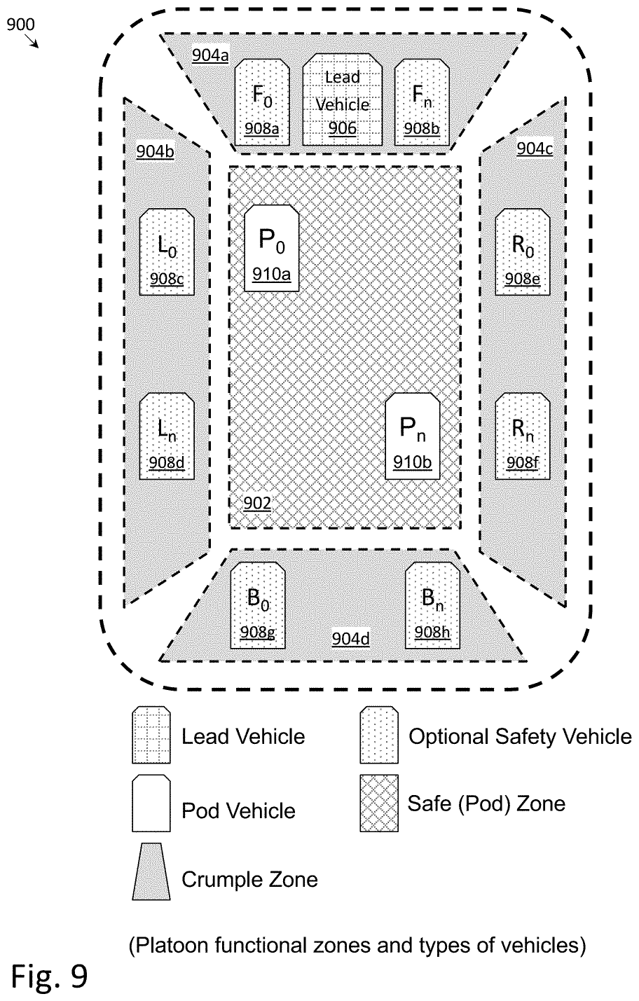

The interaction between F, A, and L may operate through a known method of platooning and vehicle following (for example, U.S. Pat. No. 6,032,097 A, titled “Vehicle platoon control system”, and GB 2551248 A, titled “Method for operating a vehicle in a platoon”). The simplest form of the invention involves using a vehicle with a crumple zone (or other energy absorbing structure) as the lead vehicle, providing protection for the vehicle “pod” A. When a collision occurs, much of the energy is absorbed by the lead vehicle, L, sparing A. In addition, communication from sensors on the lead vehicle can cause immediate braking in the pod vehicle, increasing the safety distance between the two vehicles. Similarly, a follow vehicle can provide protection from a rear collision and communication from sensors on the follow vehicle, F, can cause the pod vehicle, A, to accelerate in the event of an imminent collision to increase the safety distance between the pod vehicle, A, and the follow vehicle, F. Alternative and additional techniques for arranging and coordinating a plurality of vehicles within a platoon are described below with respect to FIGS. 9-12 below.

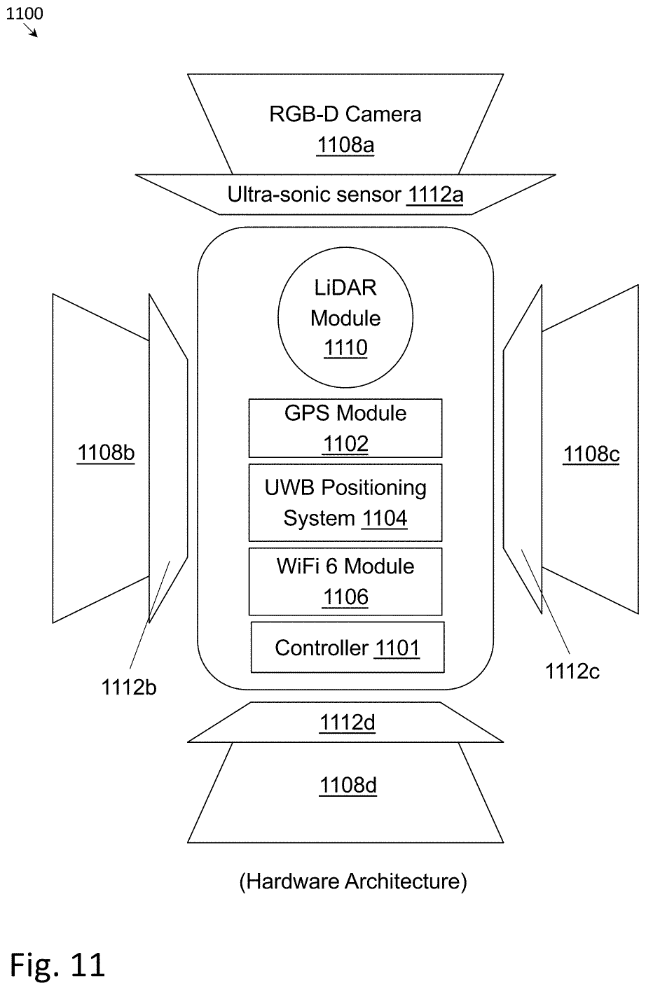

A minimal configuration of the invention can allow for a pod vehicle with no computer or sensors. This could be used, for example, to create a protection buffer for vehicles that today have no collision protection, like bicycles, scooters, and motorcycles. In this configuration where the “pod” is a vehicle without automation, the lead vehicle maintains a constant distance from the “pod” vehicle using radar sensors or other known technologies. A sample configuration with both a lead and follow vehicle is shown in FIG. 1B, showing a “pod” vehicle of a bicycle. In this configuration, the lead vehicle maintains a constant distance (or a substantially constant distance) from the pod vehicle using rear-facing radar, computer vision system, LiDAR, or similar technology. Depending on the sensor technology on the lead vehicle, the pod vehicle in this minimal configuration may require passive components such as reflective markings to discern the distance between the lead and the pod, and the degree of turning by the pod. Additional sensors of a lead or follow vehicle are described in FIG. 11.

Turning may be determined by observing the degree of turning of the front wheel of the pod vehicle and matching the same angle plus an additional number of degrees. The increased angle of turning for the lead vehicle may enable the pod and lead vehicles to be aligned following the turn. This increased angle of turning combined with the distance keeping may keep the two vehicles aligned during turns. An alternative method of turning could use a system of transmission and detection between the lead and follow vehicles. When the pod exits the outer boundary of the reflection area, the lead vehicle may turn to accommodate the motion of the pod. The follow vehicle may also use a proximity system to follow the pod in this minimal configuration.

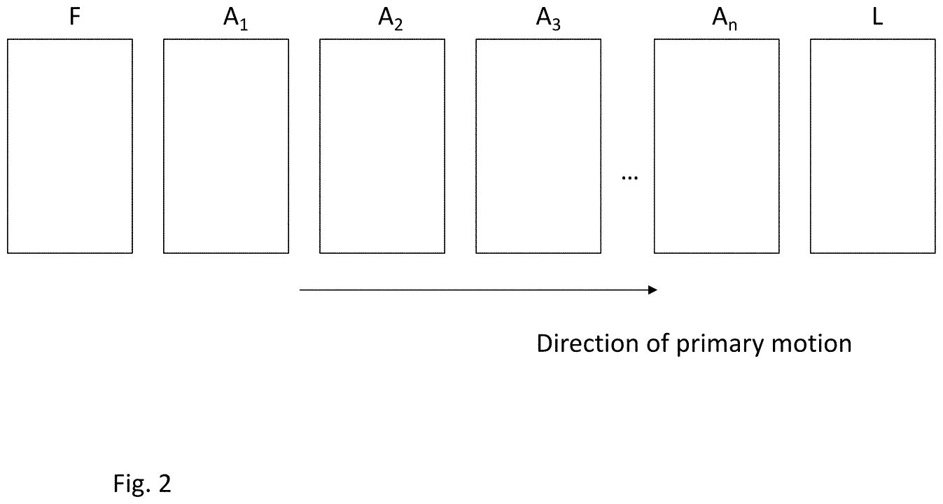

In a standard configuration, however, all classes of vehicles have power, computer(s), and sensor(s). FIG. 2 shows a standard configuration. As described above, the ability to platoon is a known technology. What is novel in this standard configuration of the invention is using the lead and follow vehicles as crash protection. Note that the follow vehicle can be simply be an empty pod following at the appropriate distance based on the energy absorption capability of the body, the friction conditions of the tire and road, and the speed of travel. This invention also enables a path to autonomous vehicles. In these modes, a follow vehicle is optional. These modes are designed to grow into fully autonomous vehicles. The modes might be needed over time as autonomy becomes more robust. They will also be useful for situations (e.g., terrain, traffic, city conditions) depending on the state of autonomy.

Mode 1: The lead vehicle is driven by a human. This invention allows the pod vehicles to take advantage of the intelligence of the human driver for routing and safety. If the pod contains passenger(s), the lead vehicle that is driven by a human enables the passenger(s) of the pod to not drive, freeing up time for other things. If the pod contains cargo, the driver can move the platoon to a location near the drop off point for the cargo and the final portion of the trip can be carried out through various means (e.g., human driven, ghost driven, autonomously guided) and over various modes of delivery (e.g., stationary pickup-box, sidewalk-guided at slow speed, air drone assisted, ground drone assisted, etc.). If the pod is an empty vehicle meant to be repositioned or being taken to a maintenance or charging facility, this invention makes more productive use of the labor time of the human driver.

With a human driver driving the lead vehicle, the pod platooning capability can be very rudimentary with just the ability to follow the vehicle in front of it and to receive commands from the lead vehicle. Alternatively, each pod can operate in a peer-to-peer mode of following the vehicle in front of it and responding to commands from it. All these methods are known in the art of platooning.

In one embodiment of repositioning with a human operator as lead vehicle, a driver begins a work period, and is directed to first pickup location. At the pickup, the driver drives the pod vehicle to be within a specific range of the lead vehicle or the last vehicle in the platoon. All vehicles drive in platoon until a drop off location for the pod vehicle. If the pod vehicle needing drop off is not at the end, the entire platoon behind it backs up to allow space for the pod vehicle to depart the platoon configuration. The driver then moves the pod vehicle to the drop off point, and returns to the lead vehicle. In the meantime, the platoon has repositioned and is ready to depart.

Mode 2: The lead vehicle is capable of remote operation. This can be a helpful transition. The lead-pod communication can remain the same as Mode 1. With a remote operator, the lead vehicle can be positioned for pickup or drop-off of a pod. The remote operator can then switch to operation of the appropriate pod vehicle (or a different remote operator can do so).

Mode 3: The lead vehicle is either remote or human driven, but the pods are autonomous at low speed or limited operational windows (e.g., along well characterized corridors, or inside a private campus, or along a side street with low speed limits). This mode allows for pods that are capable of joining and leaving a stationary or slow moving platoon. This slow moving autonomous mode has been demonstrated in production vehicles. For example, Tesla® has the “summon” function that allows a car to be placed and retrieved from a parking space.

To join a platoon, a pod needs to be within range of the platoon and may use a “summon” technology to be within range. The pod identifies the last vehicle in the platoon through sensors on the pod. The pod then accelerates to gradually reduce the distance to the last platoon vehicle. If the platoon is in motion, the rate of speed is regulated by the speed of the platoon. Finally, when the pod is within a specified distance from the last platoon pod, the pod maintains the platoon speed.

To leave a platoon, a pod slows and increases the distance from the pod leading the exiting pod. If the platoon is stationary, the exiting pod moves backward. The pod behind it has rules to maintain a minimum distance between pods, which causes it to reverse. This sequence continues to the rear most vehicle. That vehicle reverses using its sensors to avoid collision.

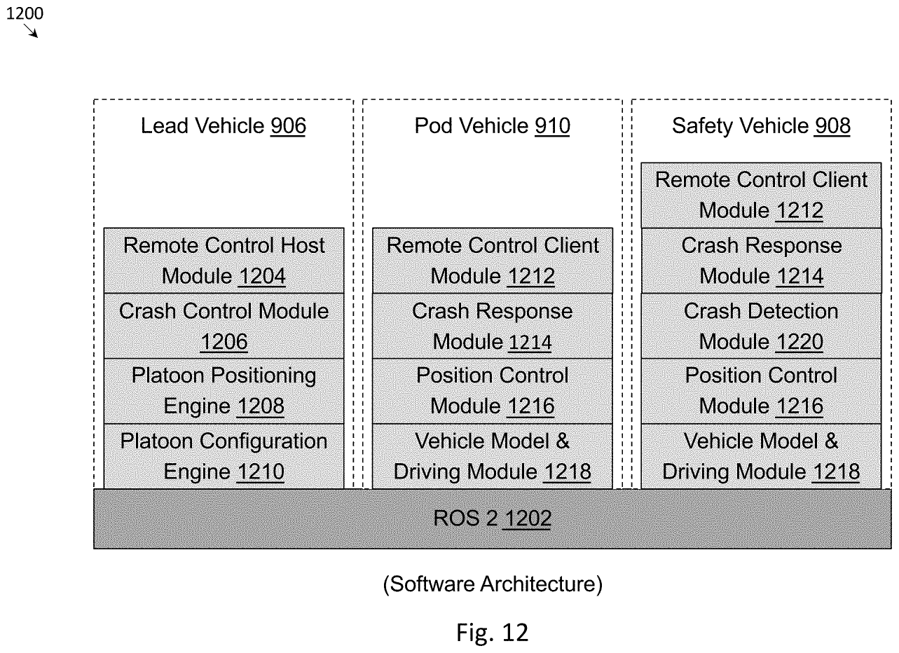

An alternative method to reverse would have the command of the entire platoon and its pod under the control of one vehicle. The control vehicle would receive a request to enter or exit a platoon and would coordinate the actions of pods and lead/follow/side vehicles. Additional techniques for orchestrating the joining or leaving of vehicles from a pod are described below with respect to FIGS. 9 and 12.

Mode 4: The lead vehicle is a Level 4 or 5 autonomous vehicle with the necessary sensor array, computer, and energy storage. The pods are human driven, remotely operated, or Mode 3 pods, all of which require lower levels of hardware and software capability.

Mode 5: Lead and pod vehicles are Level 4 or 5 autonomy.

Note, in all these modes, follow vehicles are optional. Also, follow vehicles do not need sophisticated autonomy. They can be “dumb” and just be capable of following the last vehicle in the platoon and whatever communication and command coordination is needed for reversing and platoon entry/exit.

Side Impact Protection:

In the configurations above, there is protection for front and rear collisions. This invention can also be used to provide safety for side collisions.

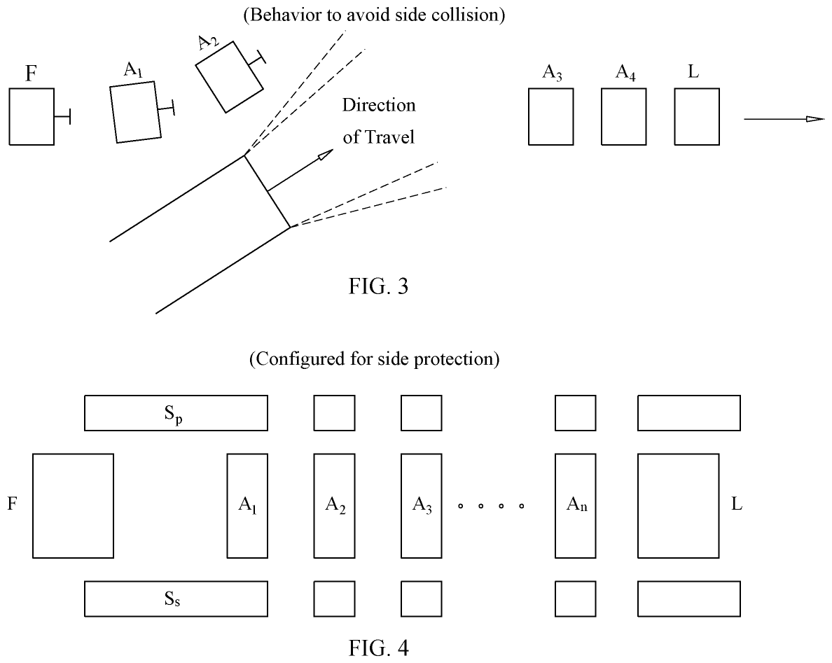

For pods with level 4 or 5 autonomy or appropriate lane-changing collisions avoidance for level 3 autonomy, their individual intelligence is enough to avoid many side collisions. As shown in FIG. 3, a platoon of pods that encounter a potential side impact can break apart and take evasive action to minimize collisions through individual collision avoidance technology in each pod. This is a method that is already known when autonomous vehicles are operating as independent vehicles. Here, they operate within a platoon while also maintaining their side collision avoidance.

A further advantage of having lead and (optionally) follow vehicles is that these vehicles can carry more sophisticated sensors, more powerful computers and communication links to the cloud. For example, a lead vehicle can be fitted with long-range LiDAR, high capacity computing and connection to the cloud for updates to high resolution road conditions and for extra computing capability. This enhanced sensor, compute and communication capability could better predict the likelihood of a potential side collision. The lead vehicle would then communicate maneuver instructions to the pod vehicles to avoid collision or minimize the damage from a collision. A similar configuration is possible using the follow vehicle. A more complex arrangement could integrate the lead and follow vehicle sensor/compute/communication capability. When lead or follow vehicles are configured with more sensing and computing capability, side impact avoidance can be implemented for platoons using pod vehicles similar to those in Modes 2 and 3. Communication between the lead or follow vehicle may instruct the individual pods on how to avoid side collisions.

FIG. 4 depicts another configuration of vehicles, in which defensive vehicles are put on the perimeter of the platoon. Here, the platoon has vehicles, Sₚ and Sₛ, on one or both sides to protect it from side impacts. These vehicles absorb energy from collisions through their bodies and also in the friction of their tires and road terrain. The side collision avoidance vehicles could be empty or cargo-carrying pods.

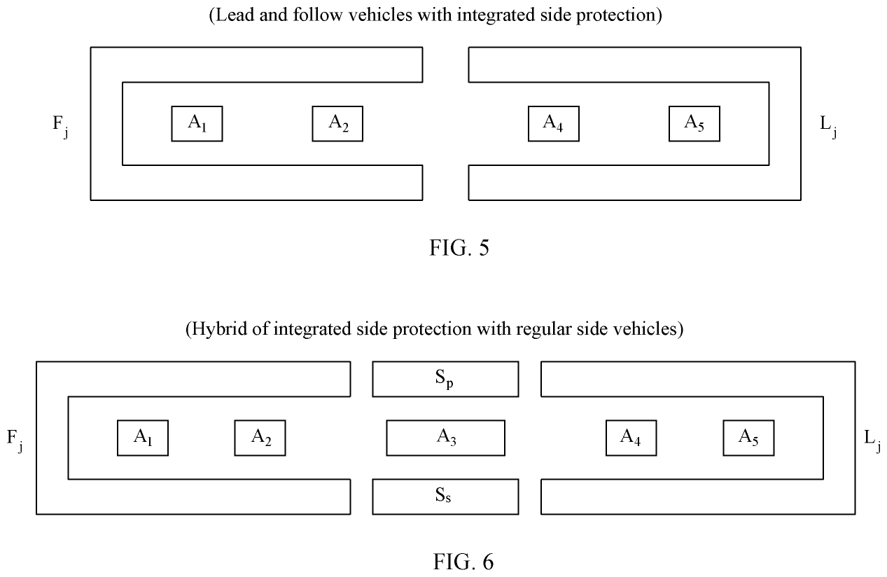

FIG. 5 depicts another configuration of vehicles, in which a plurality of vehicles A₁, A₂, A₄ and A₅ are surrounded by the lead and follow vehicles, allowing for highly safe transportation of the plurality of vehicles. FIG. 6 depicts a combination of the configurations depicted in FIGS. 4 and 5. In addition to protecting passengers and cargo from collisions, these systems can be used in military applications to enhance the protection for pod vehicles. Additional techniques for positioning defensive (or safety) vehicles at the perimeter of a platoon are described below with respect to FIG. 9.

In addition to protecting pods, side vehicles can be used to deploy sensors. In military applications, side vehicles could be used to deploy stealth technologies to minimize the visibility of a platooning set of vehicles. Side, lead, and follow vehicles can also carry weapons to defend the platoon and interior pods. Lead vehicles can be used to scan the road surface ahead using LiDAR or similar technology. This mapping can update road condition data available to vehicles in the swarm for use by adaptive suspension to smooth the ride. The information can also be used to steer around obstacles such as potholes or bumps. Lead, follow, or side vehicles can be used to communicate with infrastructure such as markers and permission to travel in restricted lanes, speed limits and traffic lights.

Side vehicles could, with adequate magnetic forces, provide stability for pod vehicles for roll and pitch. This allows pod vehicles to reduce or eliminate the need for certain wheels that provide such stability for current vehicles. Steering (yaw) can also be provided by the side vehicles by applying a differential in the magnetic force. The combination of these forces allows the pod to operate on as little as one wheel.

Side vehicles can use mechanical interfaces to stabilize pods. While metal mechanisms are possible, the preferred architecture uses air pressurized bladders to provide stabilization. Side, lead, or follow vehicles can be outfitted with fuel storage (e.g., batteries, ultra-capacitors for electricity; tanks for liquid and air fuels) and robotic fueling connections as are known in current technology. For electric vehicles, refueling can also take place using induction using known technology. Side, lead, or follow vehicles can be outfitted with video to inspect the condition of pod vehicles and other vehicles in the platoon. Side, lead, or follow vehicles can be outfitted with robotic arms to inspect the inside of other vehicles and to clean the inside and outside of the other vehicles. Side, lead, or follow vehicles can be outfitted with cargo capacity to refill the cargo space of pod vehicles. Pod vehicles can also offload cargo to side, lead, or follow vehicles to enable reverse logistics.

System configurations for re-positioning vehicles:

This invention can be used as part of an overall system that uses data about such as:
the demand for the need for vehicles,
the state of the vehicles such as location,
state of charge (or fuel), and
maintenance needs (such as cleaning).

This data is used to:
automatically determine the desired new destination of the vehicle,
direct a lead vehicle and other vehicles in the platoon to the pickup point,
direct a particular pod vehicle to join the platoon,
reroute the platoon to accommodate the new destination of that pod vehicle,
allow for updates to the desired new destination of a particular pod vehicle,
direct a particular pod vehicle to leave the platoon,
direct other pod vehicles, and (if necessary) follow and side vehicles, to allow for the entry and exit of the particular pod vehicle

Visual dynamics for art, personalization, and advertising:

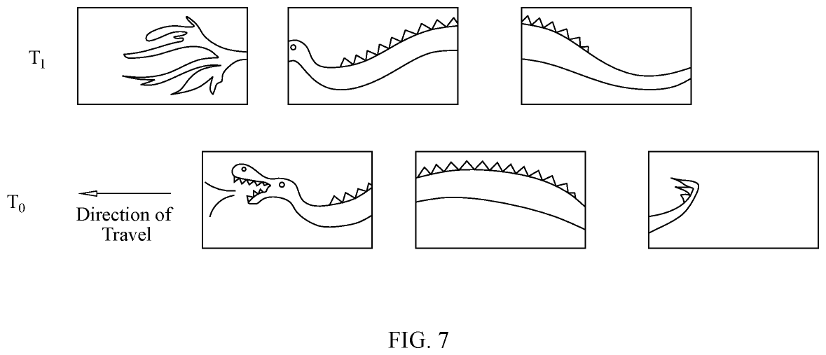

Pod, side, lead, and/or follow vehicles can be outfitted with screens and speakers for video and audio that can be seen and heard from the outside of the vehicle. These video screens, as depicted in FIG. 7, can be personalized to the occupant(s) of the vehicle, allowing each passenger to have a way to make the pod their own for the time they use it. These screens and audio can be used for a new kind of art that gives the illusion of an object persisting in a geographical location. This is accomplished by synchronizing the image on the screen and audio with the location of the screen. While similar to the methods used in augmented reality, this invention applies those techniques across many screens in motion to create the illusion of an image. This illusion can be further enhanced by adding video capture hardware and using that video image as the background for the image. Since the video image is the same as the background, it gives the illusion of seeing through the screen, similar to the current augmented reality implementations on smart phones.

The personalization and art can also change for different stages of journey (e.g., arrival, departure), location (e.g., city, highway), or time (e.g., evening, morning, Christmas, etc.).

Rain and/or Sun Protection:

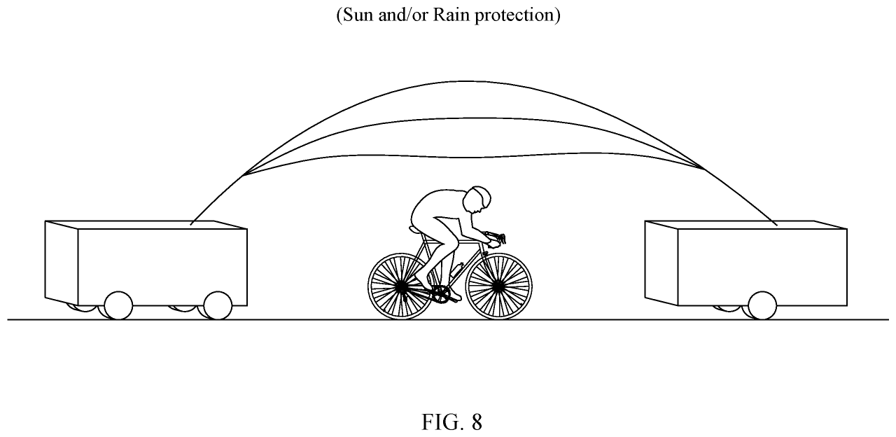

In some configurations, including the one described in FIG. 1B for motorcycles, bicycles, scooters and other open air vehicles, this new technology can be used to protect the passenger or rider from the elements. A structure can connect the lead and follow vehicles that allows adequate room for the open-air vehicle and provides protection from the elements. This overhead structure can also be used to increase the visibility of the vehicle for safety, artistic, or advertising reasons. It can also carry lighting, and/or video. FIG. 8 provides a sketch of such a configuration. The overhead structure could also be deployed between side vehicles, or other combinations of lead, side, and follow vehicles. It could also be incorporated into the follow or lead vehicles with integrated side protection shown in FIG. 5.

Exterior Airbag Integration:

To enhance the pedestrian safety further, exterior airbags can be added as described in KR20190088253A. In this and other visions of platooning, there is no description of how to have platoons operate in non-autonomous modes. The Modes 1, 2, 3 and 4 above are novel and useful technologies compared to this prior art. Furthermore, none of the prior art envisions using lead, follow, or side vehicles for safety purposes.

Additional description regarding the platoon architecture is now provided with respect to FIGS. 9-12. FIG. 9 depicts the functional zones of platoon 900, which may include a safe zone 902 (also called a pod zone) that is surrounded by a plurality of crumple zones 904a, 904b, 904c and 904d. In FIG. 9 four crumple zones are depicted, but it is understood that one or more crumple zones may be present. Within the area of the front crumple zone 904a, there may be a lead vehicle 906, which may be responsible for real world navigation, and route and formation planning of the entire platoon. Each crumple zone can have zero or more safety vehicles 908a-908h for forming a protective shield around the pod zone 902. The pod zone 902 is the safe part of the platoon 900 that is protected by the safety vehicles 908a-908h.

All pod vehicles 910a, 910b inside the platoon 900 may be positioned relative to the lead vehicle 906. The positions of pod vehicles 910a, 910b may be controlled and configured by the lead vehicle 906. These positions can be any arbitrary relative position from the lead vehicle 906 as long as a safe distance exists between all the vehicles in the platoon 900.

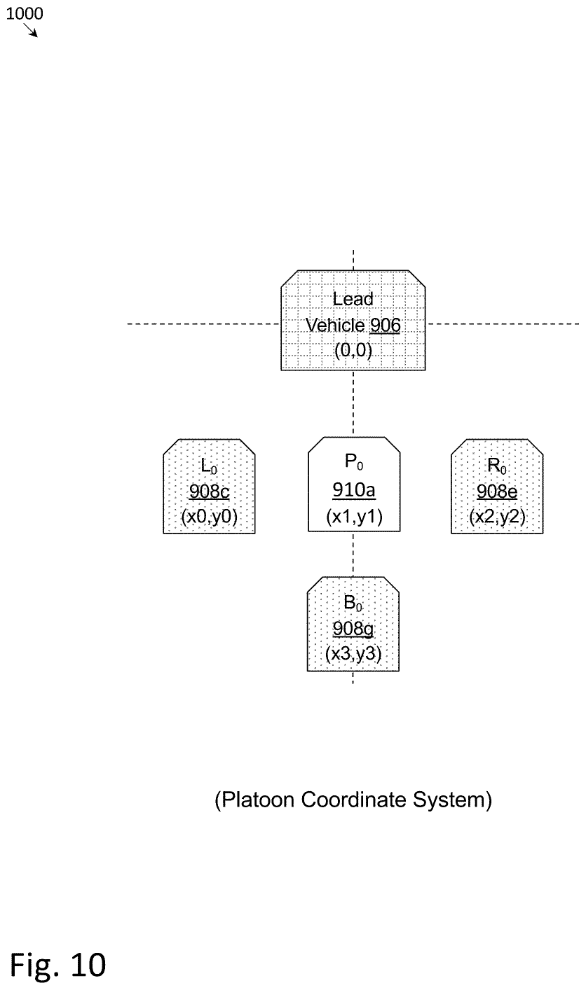

The lead vehicle 906 may be fully human driven, autonomously driven with any level of autonomy (level 1 through level 5) or even remotely operated (by a remote operator, not depicted) through a high bandwidth, low latency connection (with geographic limitations). The lead vehicle 906 may host the computer and software responsible for platoon planning, starting with defining a coordinate system 1000, as depicted in FIG. 10, that is centered about the lead vehicle 906 and defining the position of all other vehicles within that coordinate system and communicating these positions to all the vehicles in the platoon 900. The lead vehicle 906 may acquire the sizes and/or dimensions of the vehicles within the platoon 900 from each of the vehicles within the platoon 900 in order to optimally determine the respective positions of the vehicles.

All other vehicles within the platoon (i.e., other than the lead vehicle 906) may have a unique identifier (ID) that represents their respective function, and that unique ID may be assigned by the lead vehicle 906. For example, the function of safety vehicles 908a and 908b may be to form the front crumple zone 904a and protect any intrusions to the front portion of the safe zone 902; the function of safety vehicles 908c and 908d may be to form the left crumple zone 904b and protect any intrusions to the left portion of the safe zone 902; the function of safety vehicles 908e and 908f may be to form the right crumple zone 904c and protect any intrusions to the right portion of the safe zone 902; and the function of safety vehicles 908g and 908h may be to form the back crumple zone 904c and protect any intrusions to the back portion of the safe zone 902.

All other vehicles within the platoon (i.e., other than the lead vehicle 906) may maintain their (relative) position set by the lead vehicle 906 by way of full autonomous lateral and longitudinal control using the onboard computers, sensors and actuators. These other vehicles may employ sensors for detecting the respective positions of objects and/or for classifying the respective types of objects in the surrounding environment. The objects may include other vehicles within the platoon, vehicles not within the platoon, trees, poles, etc. Based on the sensory data, each of the other vehicles may determine whether the detected objects are in a crash trajectory with the platoon (or a vehicle within the platoon) and execute a configured crash/impact handling profile. The crash/impact handling profile may include full steering, throttle and brakes by wire, on board sensors and software modules later described with respect to FIG. 12. Vehicle models (size, mechanical and impact attenuation abilities) may be defined in the vehicles software and communicated back to the lead vehicle 904a. Of course, if a collision with an object can be avoided by an evasive maneuver, such an evasive maneuver may be carried out by the platoon instead of the crash/impact handling profile.

The lead vehicle 906 may define the formations and positions of the vehicles within the platoon 900. The definition process may be carried out automatically using different graph algorithms to achieve different functionalities (e.g., maximum crash protection, single file platoon, minimum road occupation area, etc.). Also, a special lead vehicle can be designed to allow a driver to remotely operate vehicles within the platoon without leaving the lead vehicle using techniques that range from manually defining a new position and orientation for the vehicle, to fully driving the vehicle remotely using the lead vehicle's steering, brakes and throttle through a screen or virtual reality (VR) headset. For example, the lead vehicle 906 may be disengaged by wire systems and the control signals provided to the lead vehicle 906 by the driver may be rerouted to control the other remote vehicle(s) by wire systems.

A new vehicle can request to join the platoon 900 if it is positioned within the vicinity of the platoon 900 (easy case if the platoon is stationary; harder case if the platoon is stationary) by sending a request to the lead vehicle 906 with its intended function/role (safety vehicle or pod vehicle). The lead vehicle 906 may respond by either rejecting the request from the new vehicle or accepting the request along with providing the new vehicle with its position within the platoon and/or updating the respective position of one or more of the other vehicles within the platoon.

A vehicle can request to leave the platoon by sending a request to the lead vehicle 906. The lead vehicle 906 may respond to such a request by sending the leaving vehicle a new position outside the platoon and/or updating the respective position of one or more of the other vehicles. In one embodiment, the driver of the lead vehicle 906 may decide to stop the movement of platoon and remotely control the leaving vehicle to direct the vehicle to a specific drop-off location.

Each vehicle (908a-908h) within the crumple zones (904a-904d) may have an impact/crash handling profile depending on the situation, type of vehicle and position of the vehicle in the platoon 900. For example, a safety vehicle that detects an imminent impact may increase a distance between itself and the pod (safe) zone 902 so as to create a larger impact absorption region to better protect the pod zone 902.

FIG. 11 depicts a block diagram 1100 of the general hardware architecture of each of the vehicles within the platoon. Each vehicle may have a full drive-by-wire system and may rely upon short-range ultrasonic sensors, global positioning system (GPS) module 1102 and ulta-wideband (UWB) positioning system 1104 for the accurate positioning of each vehicle within the platoon 900, which is essential for the position control algorithm. Wi-Fi 6 (80211ax), provided by Wi-Fi 6 module 1106, may be used for high bandwidth, low latency communication between two or more of the vehicles. Each vehicle may also include a controller 1101 that is configured to execute the various software modules described in FIG. 12.

Each of the vehicles may have one or more front, rear and side RGB-D (or range) cameras 1108a-1108d to provide depth information (i.e., information related to the depth of objects imaged by the respective cameras. Such depth information may permit remote driving of the vehicle with greater precision. Each of the vehicles may be equipped with a light detection and ranging (LiDAR) module 1110 to further increase the vehicle's ability to detect various surrounding objects and measure the distance between the vehicle and the various surrounding objects. Each of the vehicles may be equipped with one or more ulta-sonic sensors 1112a-1112d to further increase the vehicle's ability to detect various surrounding objects and measure the distance between the vehicle and the various surrounding objects.

In addition to the hardware specified in block diagram 1100, lead vehicle 906 may contain the main Wi-Fi 6 router, and additional computers and software for the configuration and positioning of the platoon's vehicles. As crumple zone vehicles (including safety vehicles and the lead vehicle) may be more prone to collisions, these vehicles may be equipped with a greater number of sensors (e.g., LiDAR, RGB-D cameras, etc.) than the pod vehicles 910a, 910b.

In the minimum configuration, the entire perimeter of the platoon 900 should be equipped with a sufficient number of LiDAR and RGB-D cameras to detect objects external to the platoon 900. In one embodiment, such minimum configuration may be implemented using a modular mounting system for the LIDAR and cameras on each vehicle and attaching the sensors at the outwardly facing locations. In another embodiment, such minimum configuration may be implemented by placing one LiDAR in each vehicle, and mounting one or more cameras on adjustable camera holders of various vehicles, such that the respective cameras can be pointed in the outwardly facing direction (i.e., pointing away from the center of the platoon).

FIG. 12 depicts the software architecture 1200 of the platoon 900. All the vehicles may be connected to the same wireless network (e.g., Wi-Fi 6), allowing for the usage of unified communication interfaces, such as ROS 2 1202, and modular software components that run on individual nodes (i.e., vehicles). As is known in the art, ROS 2 is the newest version of the robot operating system (ROS), which is a set of software libraries and tools for building robot applications.

In the lead vehicle 906, the platoon configuration engine 1210 may configure the general layout of the platoon 900 (either manually or automatically). The platoon configuration engine 1210 may also assign crash response profiles for each vehicle in the platoon 900, depending on its type and position within the platoon 900. In one embodiment, multiple crash profiles can be assigned to each vehicle and the crash control module 1206 may determine the profile that is executed by each vehicle. The platoon configuration engine 1210 may also respond to the requests of vehicles joining or leaving the platoon, and may further assign new positions for these vehicles (either joining or leaving).

The lead vehicle 906 may also include the platoon positioning engine 1208 that takes into account the sizes and/or dimensions of the vehicles in the platoon in order to generate coordinates for each vehicle in the platoon coordinate system 1000. Further, platoon positioning engine 1208 may monitor the position of each vehicle in real-time for any deviations and provide corrective measures if necessary.

The lead vehicle 906 may also include crash control module 1206 that is configured to receive data from the respective crash detection modules 1220 in the safety vehicles 908 (including potential objects in a crash trajectory) and generate a global platoon crash response event which will be executed by all the vehicles in the platoon based on their assigned profiles and the severity and direction of the predicted crash. This global platoon crash response event may be implemented as a simple lookup table or can employ a full machine learning model.

The lead vehicle 906 may also include remote control host module 1204 to allow the remote control of one or more of the vehicles within the platoon 900. In the process of handing over the control of a vehicle (pod or safety) from the lead vehicle 906 to a remote entity (not depicted), control of the vehicle by the lead vehicle 906 may be disengaged; control of the vehicle by the remote entity may be engaged; and finally, any feedback from the (now) remotely controlled vehicle may be transmitted to the lead vehicle 906. Such feedback may include visual feedback from the cameras of the remotely controlled vehicle and physical feedback from the steering (and other controls) of the remotely controlled vehicle. Also, in case of an operator using a VR headset, remote control host module 1204 may construct a 360° view from the remotely controlled vehicle.

In each pod vehicle 910 or safety vehicle 908, the vehicle model and driving module 1218 may attend to the low level controls of the vehicle, such as steering, throttling and braking. Based on the size and kinematics of the vehicle, vehicle model and driving module 1218 may determine the impact energy absorption capabilities of the vehicle. The vehicle size and impact energy absorption capabilities may be reported, by vehicle model and driving module 1218, to the lead vehicle 906 to be used for safety-aware positioning of the vehicles. Each pod vehicle 910 or safety vehicle 908 may include a position control module 1216 that is configured to maintain the vehicle's assigned position within the platoon 900 based on information from the vehicle model and driving module 1218, the platoon configuration engine 1210 and platoon positioning engine 1208. Each pod vehicle 910 or safety vehicle 908 may include a remote control client module 1212 that is configured to receive remote control commands from the remote control host module 1204, execute the receive commands, and send feedback to the remote control host module host 1204 (visual and physical).

Each safety vehicle 908 may include crash detection module 1220 that is configured to detect and classify one or more objects near the safety vehicle 908 and determine the respective probabilities of the safety vehicle 908 crashing with each of the one or more objects. Such information determined by crash detection module 1220 may be transmitted to the crash control module 1206 of lead vehicle 906. All vehicles may include a crash response module 12 that, upon a determined imminent collision with an object, executes the crash response profile that is received from the crash control module 1206.

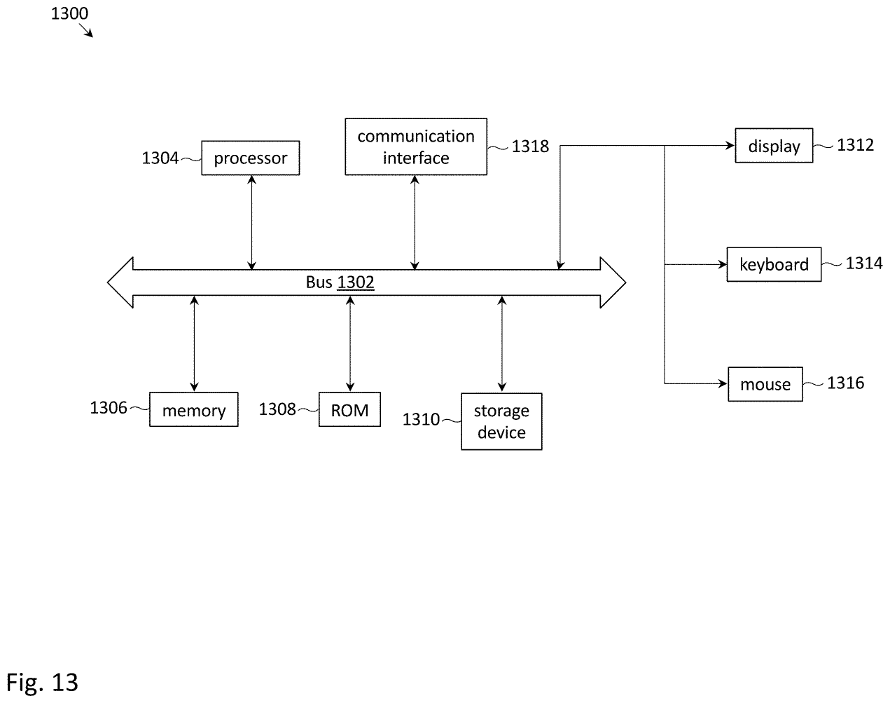

As is apparent from the foregoing discussion, aspects of the present invention involve the use of various computer systems and computer readable storage media having computer-readable instructions stored thereon. FIG. 13 provides an example of system 1300 that may be representative of any of the computing systems discussed herein (e.g., controller 1101). Note, not all of the various computer systems have all of the features of system 1300. For example, certain ones of the computer systems discussed above may not include a display inasmuch as the display function may be provided by a client computer communicatively coupled to the computer system or a display function may be unnecessary. Such details are not critical to the present invention.

System 1300 includes a bus 1302 or other communication mechanism for communicating information, and a processor 1304 coupled with the bus 1302 for processing information. Computer system 1300 also includes a main memory 1306, such as a random access memory (RAM) or other dynamic storage device, coupled to the bus 1302 for storing information and instructions to be executed by processor 1304. Main memory 1306 also may be used for storing temporary variables or other intermediate information during execution of instructions to be executed by processor 1304. Computer system 1300 further includes a read only memory (ROM) 1308 or other static storage device coupled to the bus 1302 for storing static information and instructions for the processor 1304. A storage device 1310, for example a hard disk, flash memory-based storage medium, or other storage medium from which processor 1304 can read, is provided and coupled to the bus 1302 for storing information and instructions (e.g., operating systems, applications programs and the like).

Computer system 1300 may be coupled via the bus 1302 to a display 1312, such as a flat panel display, for displaying information to a computer user. An input device 1314, such as a keyboard including alphanumeric and other keys, may be coupled to the bus 1302 for communicating information and command selections to the processor 1304. Another type of user input device is cursor control device 1316, such as a mouse, a trackpad, or similar input device for communicating direction information and command selections to processor 1304 and for controlling cursor movement on the display 1312. Other user interface devices, such as microphones, speakers, etc. are not shown in detail but may be involved with the receipt of user input and/or presentation of output.

The processes referred to herein may be implemented by processor 1304 executing appropriate sequences of computer-readable instructions contained in main memory 1306. Such instructions may be read into main memory 1306 from another computer-readable medium, such as storage device 1310, and execution of the sequences of instructions contained in the main memory 1306 causes the processor 1304 to perform the associated actions. In alternative embodiments, hard-wired circuitry or firmware-controlled processing units may be used in place of or in combination with processor 1304 and its associated computer software instructions to implement the invention. The computer-readable instructions may be rendered in any computer language.

In general, all of the above process descriptions are meant to encompass any series of logical steps performed in a sequence to accomplish a given purpose, which is the hallmark of any computer-executable application. Unless specifically stated otherwise, it should be appreciated that throughout the description of the present invention, use of terms such as “processing”, “computing”, “calculating”, “determining”, “displaying”, “receiving”, “transmitting” or the like, refer to the action and processes of an appropriately programmed computer system, such as computer system 1300 or similar electronic computing device, that manipulates and transforms data represented as physical (electronic) quantities within its registers and memories into other data similarly represented as physical quantities within its memories or registers or other such information storage, transmission or display devices. Computer system 1300 also includes a communication interface 1318 coupled to the bus 1302. Communication interface 1318 may provide a two-way data communication channel with a computer network, which provides connectivity to and among the various computer systems discussed above. For example, communication interface 1318 may be a local area network (LAN) card to provide a data communication connection to a compatible LAN, which itself is communicatively coupled to the Internet through one or more Internet service provider networks. The precise details of such communication paths are not critical to the present invention. What is important is that computer system 1300 can send and receive messages and data through the communication interface 1318 and in that way communicate with hosts accessible via the Internet.

Thus, a swarming and platooning technology has been described. It is to be understood that the above-description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A system, comprising:
a lead vehicle; and
a pod vehicle disposed behind the lead vehicle,
wherein the lead vehicle is configured to protect the pod vehicle from a potential impact to a front portion of the pod vehicle,
wherein the lead vehicle is configured to be autonomously driven, and
wherein the lead vehicle and the pod vehicle form a heterogeneous group of vehicles.

2. A system, comprising:
a lead vehicle;
a following vehicle; and
a pod vehicle disposed between the lead and the following vehicle,
wherein the lead vehicle is configured to protect the pod vehicle from a potential impact to a front portion of the pod vehicle,
wherein the following vehicle is configured to protect the pod vehicle from a potential impact to a rear portion of the pod vehicle,
wherein the lead and following vehicles are configured to be autonomously driven, and
wherein the lead vehicle, the pod vehicle and the following vehicle form a heterogeneous group of vehicles.

3. The system of claim 2, further comprising:
a side vehicle disposed adjacent to a side portion of the pod vehicle, wherein the side vehicle is configured to protect the pod from a potential impact to a side portion of the pod vehicle, and wherein the side vehicle is configured to be autonomously driven.

4. The system of claim 2, further comprising:
a shielding element attached to the lead vehicle and the following vehicle, the shielding element configured to protect the pod vehicle from at least one of rain or sunlight.

5. The system of claim 2, wherein the pod vehicle is a bicycle.

6. The system of claim 2, further comprising:
a first electronic display mounted to the lead vehicle;
a second electronic display mounted to the pod vehicle; and
a third electronic display mounted to the following vehicle, wherein the first, second and third electronic display are configured to collectively display a single image or a single video.

7. The system of claim 2, wherein the lead vehicle is further configured to protect the pod vehicle from a potential impact to a side portion of the pod vehicle.

8. The system of claim 2, wherein the following vehicle is further configured to protect the pod vehicle from a potential impact to a side portion of the pod vehicle.

9. A system, comprising:
a lead vehicle;
a following vehicle; and
a plurality of pod vehicles disposed between the lead and the following vehicle,
wherein the lead vehicle is configured to protect one or more of the pod vehicles from a potential impact to a front portion of each of the one or more pod vehicles,
wherein the following vehicle is configured to protect one or more of the pod vehicles from a potential impact to a rear portion of each of the one or more pod vehicles,
wherein the lead and following vehicles are configured to be autonomously driven, and
wherein the lead vehicle, the plurality of pod vehicles and the following vehicle form a heterogeneous group of vehicles.

10. The system of claim 9, wherein the lead vehicle is further configured to protect one or more of the pod vehicles from a potential impact to a side portion of each of the one or more pod vehicles.

11. The system of claim 10, wherein the following vehicle is further configured to protect one or more of the pod vehicles from a potential impact to a side portion of each of the one or more pod vehicles.

12. The system of claim 11, further comprising:
a side vehicle disposed adjacent to a side portion of one or more of the pod vehicles, wherein the side vehicle is configured to protect the one or more pod vehicles from a potential impact to a side portion of each of the one or more pod vehicles, and wherein the side vehicle is configured to be autonomously driven.
